(19) United States
(12) Patent Application Publication
(10) Pub. No.: US 2025/0005170 A1
(43) Pub. Date: Jan. 2, 2025

(54) INFORMATION PROCESSING DEVICE

(71) Applicant: TOYOTA JIDOSHA KABUSHIKI KAISHA, Toyota-shi (JP)

(72) Inventors: Shintaro MATSUTANI, Kariya-shi (JP); Ryuichi DANNO, Kasugai-shi (JP); Atsushi IKEGAYA, Aisai-shi (JP); Masashi NOMOTO, Tokyo (JP); Oral KAPLAN, Tokyo (JP)

(73) Assignee: TOYOTA JIDOSHA KABUSHIKI KAISHA, Toyota-shi (JP)

(21) Appl. No.: 18/647,491

(22) Filed: Apr. 26, 2024

(30) Foreign Application Priority Data
Jun. 28, 2023 (JP) 2023-105940

(51) Int. Cl. G06F 21/60; G06F 21/31

(52) U.S. Cl. CPC G06F 21/60; G06F 21/31; G06F 2221/2115

(57) ABSTRACT

An information processing device includes a control unit. The control unit acquires user information indicating whether or not the first user is permitted to provide the third party with the first data related to the travel received from the vehicle on which the first user is riding. Then, when the first user is permitted to provide the first data to the third party, the control unit transmits the first data to the third party server. In addition, when the first user does not allow the first data to be provided to the third party, the control unit prohibits the transmission of the first data to the third party server.

### CROSS-REFERENCE TO RELATED APPLICATION

This application claims priority to Japanese Patent Application No. 2023-105940 filed on Jun. 28, 2023, incorporated herein by reference in its entirety.

### BACKGROUND

### 1. Technical Field

The present disclosure relates to an information processing device that collects data related to travel of a vehicle.

### 2. Description of Related Art

Japanese Unexamined Patent Application Publication No. 2014-241098 (JP 2014-241098 A) discloses a sensor data management system. In the sensor data management system disclosed in JP 2014-241098 A, a server that manages sensor data executes anonymization processing in accordance with the definition contents of an anonymization policy setting file. In the anonymization processing, the server individually anonymizes designated data items of the sensor data according to designated conditions. In addition, a combination of any data items of the sensor data including the anonymized sensor data generated by the anonymization processing is transmitted to another server.

### SUMMARY

An object of the present disclosure is to make it possible to restrict, for each user, the provision of data related to travel of a vehicle used by a plurality of users to a third party.

An information processing device according to the present disclosure includes a control unit that executes:

receiving first data related to travel from a vehicle;
identifying a first user on the vehicle; and
acquiring user information indicating whether the first user allows to provide a third party with the first data received from the vehicle on which the first user is, in which
in the user information, when the first user allows to provide the third party with the first data, the control unit transmits the first data to a third party server, and
in the user information, when the first user does not allow to provide the third party with the first data, the control unit prohibits transmitting the first data to the third party server.

According to the present disclosure, it is possible to restrict, for each user, the provision of data related to travel of a vehicle used by a plurality of users to a third party.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a flow of data in a data providing system according to an embodiment;

FIG. 2 is a diagram illustrating an example of a table configuration of travel data transmitted from a vehicle to a management server;

FIG. 3 is a block diagram schematically illustrating a configuration of a management server;

FIG. 4A is a diagram illustrating an example of a table configuration of a schedule-information database;

FIG. 4B is a diagram illustrating an example of a table configuration of a user information database;

FIG. 5 is a flowchart illustrating a flow of information processing executed by a control unit of the managing server in the embodiment; and

FIG. 6 is a flowchart illustrating a flow of information processing executed by a control unit of a management server in a modification of the embodiment.

### DETAILED DESCRIPTION OF EMBODIMENTS

In recent years, efforts have been made to collect traveling data (hereinafter, sometimes referred to as “traveling data”) from many vehicles and utilize the collected traveling data as big data. On the other hand, for example, one vehicle may be used by a plurality of users, such as a vehicle for car sharing service. In such a case, not all of the plurality of users using the vehicle are allowed to provide the traveling data of the vehicle as big data while the vehicle is riding. That is, some of a plurality of users using one vehicle may not be allowed to provide travel data of the vehicle on board to a third party. Here, the third party is a person who utilizes the collected traveling data as big data. Therefore, the present disclosure provides a technique that makes it possible to restrict, for each user, provision of data related to traveling of a vehicle used by a plurality of users to a third party.

An information processing device according to the present disclosure includes a control unit. The control unit receives the first data from the vehicle. The first data is travel data. The first data may be acquired while the vehicle is traveling by various sensors mounted on the vehicle. The vehicle is a vehicle used by a plurality of users. Then, the control unit identifies the first user who is riding on the vehicle. For example, the control unit may identify the first user who is riding on the vehicle on the basis of the information on the use schedule of the vehicle by each user. Further, the control unit may identify the first user who is riding on the vehicle by receiving the user ID identifying the first user who is riding on the vehicle from the vehicle.

In addition, the control unit acquires user information of the first user. Here, the user information includes information indicating whether or not the first user is permitted to provide the third party with the first data received from the vehicle on which the first user is riding. It should be noted that the first user may set at an arbitrary timing whether or not to allow the third party to provide the first data of the vehicle in which the first user is riding.

Then, based on the user information of the first user, the control unit determines whether or not to transmit the first data received from the vehicle on which the first user is riding to the third party server. That is, in the user information, when the first user is permitted to provide the first data to the third party, the control unit transmits the first data to the third party server. On the other hand, in the user information, when the first user is unauthorized to provide the first data to the third party, the control unit prohibits the transmission of the first data to the third party server. Here, the third party server is a server device related to a third party that utilizes the traveling data as big data. Note that the control unit may transmit the first data received from the vehicle to the third party server in a state where some processing is performed instead of the state as it is.

According to the present disclosure, the first data is not transmitted to the third party server if the first user does not allow to provide the third party with the first data of the vehicle on board. In other words, the control unit can transmit the first data to the third party server only when the first user allows to provide the third party with the first data of the vehicle in which the first user is riding.

Hereinafter, an embodiment of the present disclosure will be described with reference to the drawings. The dimensions, materials, shapes, relative arrangements, and the like of the components described in the present embodiment do not limit the technical scope of the present disclosure, unless otherwise specified.

### Embodiment

### System Overview

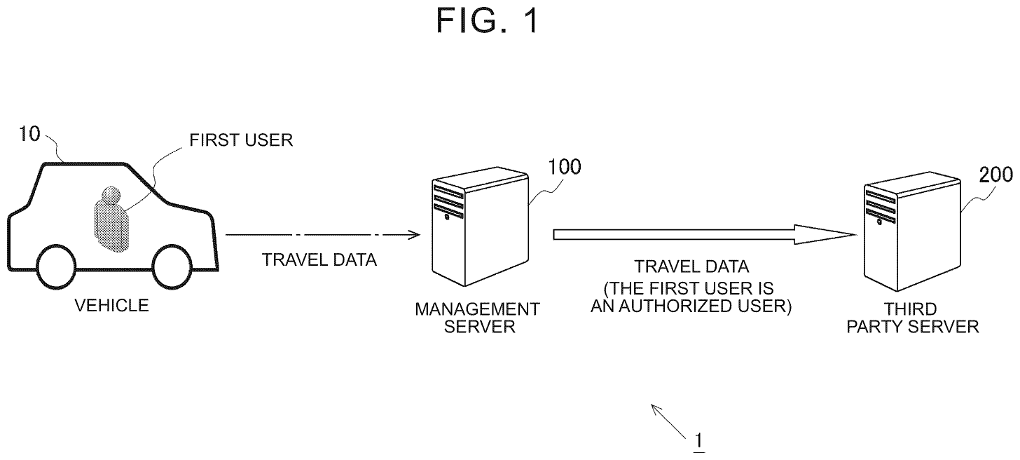

FIG. 1 is a diagram illustrating a flow of data in a data providing system according to the present embodiment. The data providing system 1 is a system for collecting travel data from the vehicle 10 and providing the collected travel data to a third party. The vehicle 10 is a vehicle for car sharing service. That is, the vehicle 10 is used by a plurality of users who receive the car sharing service. A plurality of users who can use the vehicle 10 may be registered in advance. Note that the vehicle 10 is not necessarily a vehicle for car sharing service, and may be any vehicle that can be individually used by a plurality of users.

The data providing system 1 includes a vehicle 10, a management server 100, and a third party server 200. The management server 100 is a server device that collects traveling data from the vehicle 10. The third party server 200 is a server device related to a third party that uses travel data of the vehicle 10 as big data. In the present embodiment, the management server 100 corresponds to an “information processing device” according to the present disclosure. Further, the data providing system 1 may include a plurality of vehicles 10, and the management server 100 may collect travel data from each of the plurality of vehicles 10.

The vehicle 10, the management server 100, and the third party server 200 are connected to each other via a network. Here, as the network, for example, a Wide Area Network (WAN) which is a public communication network such as the Internet or a telephone communication network such as a mobile telephone may be adopted. The network may also include telephone communication networks for cellular phones and the like, and wireless communication networks such as Wi-Fi (registered trademark).

The vehicle 10 includes various sensors for acquiring travel data. Then, the vehicle 10 transmits the travel data acquired during the travel to the management server 100 at a predetermined timing. For example, the vehicle 10 may periodically transmit the traveling data to the management server 100 at predetermined intervals during traveling.

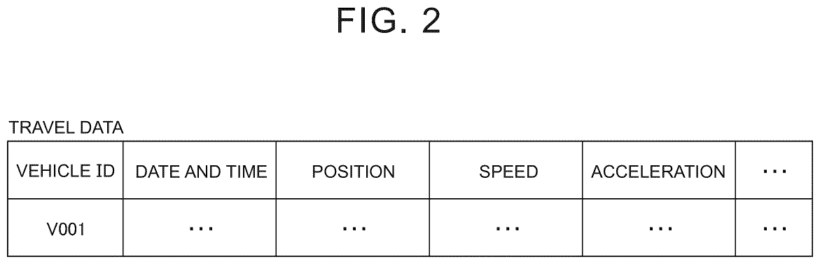

FIG. 2 is a diagram illustrating an example of a table configuration of travel data transmitted from the vehicle 10 to the management server 100. As shown in FIG. 2, the travel data includes vehicle ID fields, datetime fields, position fields, velocity fields, and acceleration fields. In the vehicle ID field, a vehicle ID that is identification information for identifying the vehicle 10 that is the source of the traveling data is inputted. In the date and time field, information about the date and time when the travel data is acquired in the vehicle 10 is input. The position information of the vehicle 10 is input to the position field. In the speed field, speed information of the vehicle 10 is input. The acceleration information of the vehicle 10 is input to the acceleration field. In addition, ON and OFF of the start button (or the ignition switch) of the vehicle 10 may be determined. Further, the traveling data may include image information captured by a camera mounted on the vehicle 10. The traveling data does not necessarily have to be data acquired by a sensor mounted on the vehicle 10. In the present embodiment, the traveling data corresponds to “first data” according to the present disclosure.

The management server 100 transmits the traveling data of the vehicle 10 to the third party server 200 in response to a request from a third party. As a result, the third party can receive the travel data to be used as the big data. However, at least some of the users of the plurality of users using the vehicle 10 may not allow the user to provide travel data of the vehicle 10 to a third party while the user is riding. That is, there is a case where the user who is riding on the vehicle 10 is a user who is permitting the user to provide the traveling data of the vehicle 10 that is riding on the vehicle to a third party. On the other hand, a user who is riding on the vehicle 10 (hereinafter, sometimes referred to as “permitted user”) may be a user who is not permitted to provide travel data of the vehicle 10 on the vehicle to a third party (hereinafter, sometimes referred to as “unauthorized user”).

Therefore, in the present embodiment, the first user who is riding on the vehicle 10 is identified. Then, the management server 100 transmits the traveling data of the vehicle 10 to the third party server 200 when the first user who is riding is an authorized user. On the other hand, the management server 100 prohibits the transmission of the traveling data of the vehicle 10 to the third party server 200 when the first user who is riding is an unauthorized user.

### Configuring the Management Server

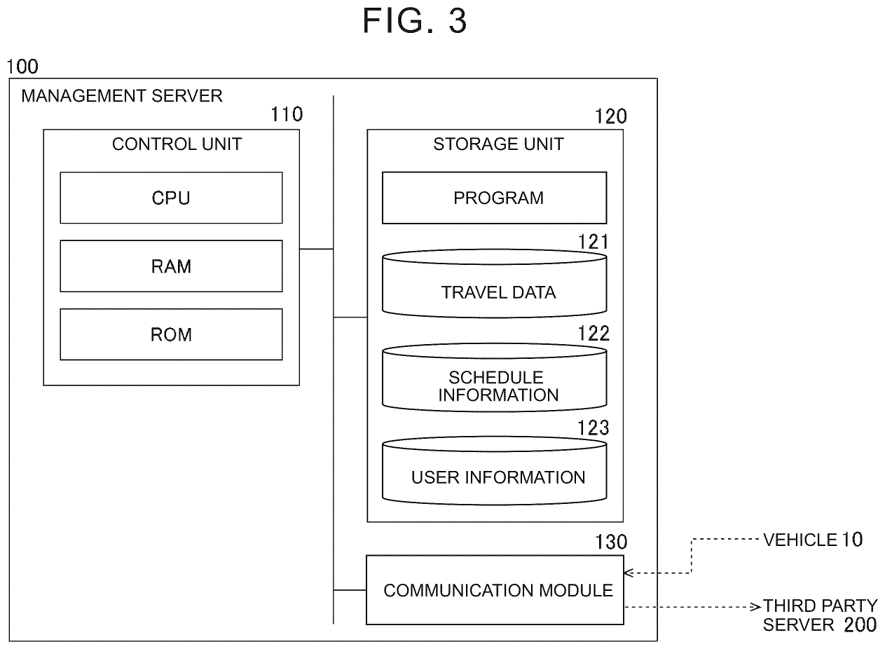

Next, the configuration of the management server 100 will be described. FIG. 3 is a block diagram schematically illustrating a configuration of the management server 100. The management server 100 includes a control unit 110, a storage unit 120, and a communication module 130. The control unit 110 has a function of performing arithmetic processing for controlling the management server 100. The control unit 110 includes a processor such as Central Processing Unit (CPU), a main storage device such as Random Access Memory (RAM), and a secondary storage device such as Read Only Memory (ROM). CPU is an exemplary processor resource. In addition, RAM and ROM are exemplary memory-resources. The control unit 110 can execute arbitrary information processing based on various programs and various data. However, some or all of the functions of the control unit 110 may be realized by a hardware-circuit such as an ASIC, FPGA.

The storage unit 120 is constituted by any storage device such as a RAM, ROM, a hard disk drive, or a flash memory. The storage unit 120 may include a removable medium (portable recording medium). Here, the removable medium is, for example, a USB memory, a SD card, or a disc recording medium such as a CD-ROM, DVD disc or a Blu-ray disc. The storage unit 120 stores programs to be executed by the control unit 110 and various types of data to be used for executing the programs.

In the storage unit 120, a database for storing travel data 121 received from the vehicle 10 is constructed. When the data providing system 1 includes a plurality of vehicles 10, travel data 121 is stored in the database for each vehicle 10.

In the storage unit 120, a database (schedule information database) for storing the schedule information 122 and a database (user information database) for storing the user information 123 are constructed. The schedule information 122 is information related to a usage schedule of the vehicle 10 by each user. The user information is information indicating whether or not each user is permitted to provide the travel data 121 received from the vehicle 10 in which the user is riding to a third party.

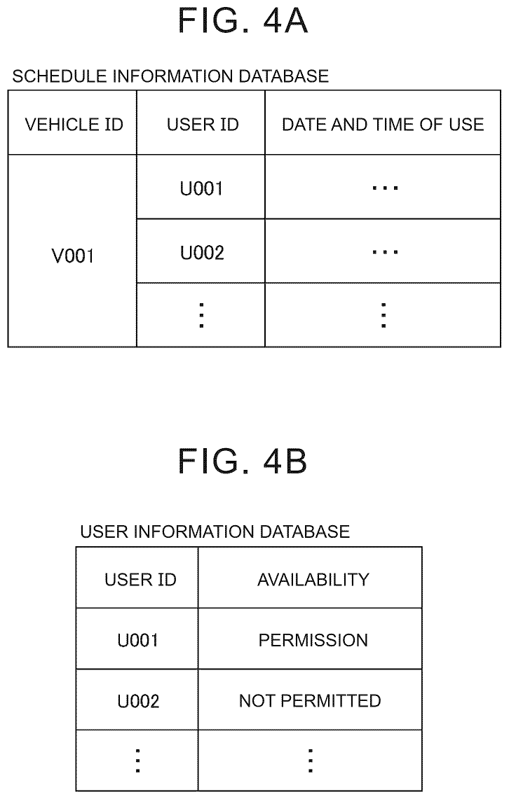

FIG. 4A is a diagram illustrating an example of a table configuration of a schedule-information database. FIG. 4B is a diagram illustrating an example of a table configuration of a user information database. As shown in FIG. 4A, the scheduling information database includes a vehicle ID field, a user ID field, and a usage date and time field. A vehicle ID that is identification information for identifying the vehicle 10 is input to the vehicle ID field. In the user ID field, a user ID that is identification information for identifying users who use the vehicles 10 is inputted. In the use date and time field, the use date and time of the vehicle 10 by each user is input. In the schedule information database, when the user has reserved the use of the vehicle 10, the date and time and the user ID of the use schedule registered by the user may be inputted. Further, in the schedule-information database, when the user finishes using the vehicle 10, the date and time and the user ID of the use record registered by the user may be inputted.

As shown in FIG. 4B, the user data base includes a user ID field and a provision availability field. In the user ID field, a user ID that is identification information for identifying users who use the vehicles 10 is inputted. In the provision availability field, information indicating whether or not each user is permitted to provide the travel data 121 received from the vehicle 10 in which the user is riding to a third party is input. In the user information database, information registered in advance by the user is input. Note that each user may register user information via a user terminal associated with the user.

The communication module 130 is a communication interface for connecting the management server 100 to a network. The communication module 130 is, for example, a Local Area Network (LAN) interface board or wireless communication circuitry for wireless communication. However, the management server 100 may not be necessarily realized by a single physical configuration, and may be configured by a plurality of computers that cooperates with each other.

### Flow of Information Processing

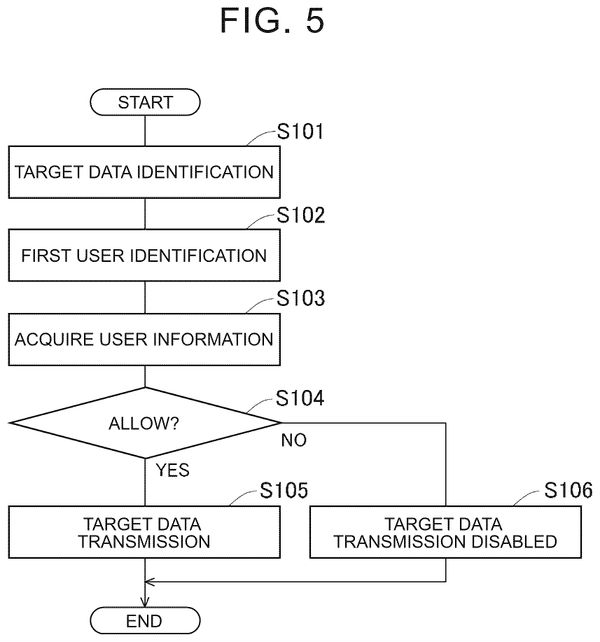

Next, a flow of information processing executed by the management server 100 will be described with reference to FIG. 5. FIG. 5 is a flowchart illustrating a flow of information processing executed by the control unit 110. Note that this flow is executed in a state where the travel data 121 of the vehicle 10 is stored in a database constructed in the storage unit 120. For example, when a data provision request is received from the third party server 200, the control unit 110 may execute this flow. In addition, the control unit 110 may execute this flow every predetermined period.

In this flow, first, in S101, data that can be a target of data transmission to the third party server 200 (hereinafter, sometimes referred to as “target data”) is specified from the travel data 121 of the vehicle 10 stored in the database of the storage unit 120. For example, the target data may be specified based on the date and time when the travel data 121 is acquired in the vehicle 10. In addition, a predetermined condition for specifying the target data in the data provision request transmitted from the third party server 200 to the management server 100 may be included. In this case, the target data is specified based on a predetermined condition included in the data provision request.

Next, in S102, the first user who is riding on the vehicle 10 when the target data identified by S101 is acquired in the vehicle 10 is identified. Specifically, the user who used the vehicle 10 at the acquisition date and time of the data in the vehicle 10 included in the target data is identified as the first user. At this time, the control unit 110 identifies the first user by referring to the schedule information 122 stored in the schedule information database.

Next, in S103, the user information 123 of the first user identified by S102 is obtained from the user information database. Specifically, the user information corresponding to the user ID of the first user is extracted from the user information database. Next, in S104, it is determined whether the first user is an authorized user or an unauthorized user. Specifically, the control unit 110 determines whether or not the first user is permitted to provide the travel data 121 received from the vehicle 10 in which the first user is riding to a third party by referring to the provision availability field of the user information 123 acquired by S103.

When an affirmative determination is made in S104, that is, when the first user is an authorized user, S105 process is executed next. In S105, the target data is transmitted to the third party server 200. At this time, the control unit 110 may perform processing according to a request from a third party on the travel data 121 stored in the database of the storage unit 120, and then transmit the target data to the third party server 200.

On the other hand, when a negative determination is made in S104, that is, when the first user is an unauthorized user, S106 process is executed next. In S106, transmission of the target data to the third party server 200 is prohibited.

According to the flow as described above, the travel data 121 of the vehicle 10 when the first user on board is an unauthorized user is not transmitted to the third party server 200. In other words, only the travel data 121 of the vehicle 10 when the first user on board is an authorized user is transmitted to the third party server 200. Therefore, it is possible to restrict the provision of the data related to the travel of the vehicle 10 used by the plurality of users to the third party for each user.

Note that the vehicle 10 may be equipped with an in-vehicle terminal 11 capable of performing an input operation by a user who is riding on the vehicle 10. The in-vehicle terminal is a computer including a processor such as a CPU, a RAM, ROM, a hard disk drive, a storage device such as a flash memory, and a communication module. The in-vehicle terminal is connected to the management server 100 via a network.

In this case, the user riding on the vehicle 10 may input the user information to the in-vehicle terminal. That is, information indicating whether or not the user who has ridden on the vehicle 10 permits the travel data 121 received from the vehicle 10 in which the user is riding to be provided to a third party may be input to the in-vehicle terminal. User information may be transmitted from the in-vehicle terminal to the management server 100. Upon receiving the user information from the in-vehicle terminal, the management server 100 stores the received user information in the user information database.

### Modified Examples

A modified example of the present embodiment will be described hereinbelow. In this modification, it is assumed that the provider providing the car sharing service to the user is the owner of the vehicle 10. In this case, the owner of the vehicle 10 is not necessarily a person, and may be a corporation or the like.

Here, it is possible that the owner of the vehicle 10 contracts with a third party to provide the travel data 121 of the vehicle 10 to the third party when the user uses the vehicle 10. When such a contract exists, normally, the travel data 121 acquired in the vehicle 10 and transmitted to the management server 100 is transmitted from the management server 100 to the third party server 200 regardless of which user is a user who is riding on the vehicle 10. However, even in such a case, the owner of the vehicle 10 may select whether or not the user is permitted to provide the travel data 121 of the vehicle 10 on board to a third party. If the owner of the vehicle 10 makes such a setting, the management server 100 can perform the same information processing as in the above-described embodiment.

Therefore, in this modification, an owner information database for storing owner information is constructed in the storage unit 120 of the management server 100. Here, the owner information is information indicating whether or not the owner of the vehicle 10 can select whether or not to allow the user to provide the travel data 121 of the vehicle 10 in which the user is riding to a third party. Then, in the management server 100, the control unit 110 refers to the owner information stored in the owner information database.

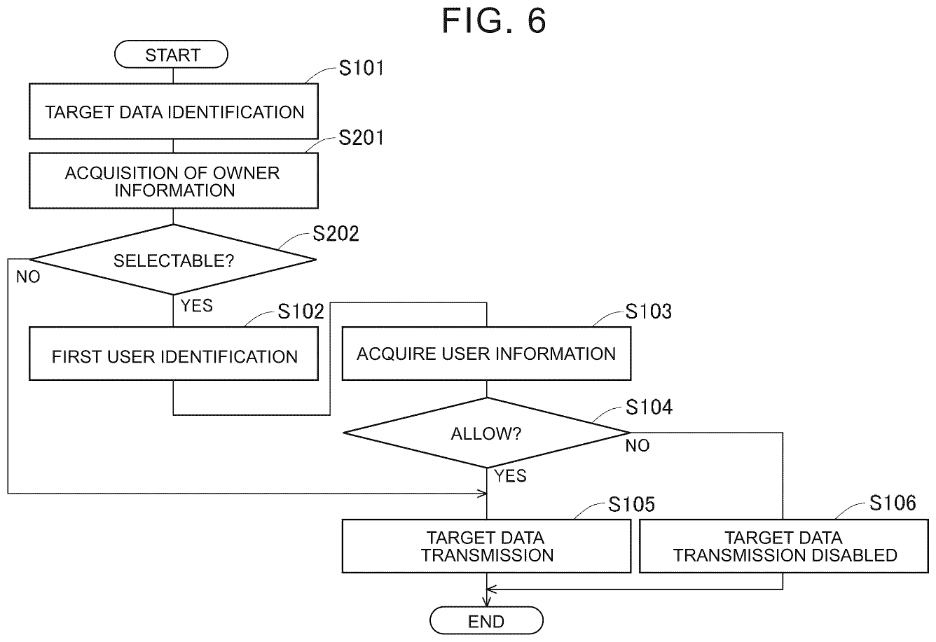

FIG. 6 is a flowchart illustrating a part of the flow of information processing executed by the control unit 110 in the present modification. Note that, in this flow, the processes executed in S106 steps from S101 are the same as the processes executed in the steps with the same reference numerals in the flow chart shown in FIG. 5. Therefore, descriptions of these steps will be omitted, and processing in S201 and S202 will be described.

In this flow, the process of S201 is executed following S101. In S201, the owner information of the owner of the vehicle 10 is obtained from the owner information database. Next, in S202, the owner data obtained in S201 is referred to. It is determined whether or not the owner of the vehicle 10 is configured so that the user can select whether or not to allow the user to provide the travel data 121 of the vehicle 10 on board to a third party.

If an affirmative determination is made in S202, that is, if the user is able to select whether or not to allow the user to provide the travel data 121 of the vehicle 10 on board to a third party, S102 process is executed next. On the other hand, if a negative determination is made in S104, S105 process is executed next.

According to the above-described flow, in a case where the owner of the vehicle 10 is set so as to be able to select whether or not the user on the vehicle 10 is permitted to provide the travel data 121 to the third party, the same information processing as in the above-described embodiment is executed. That is, whether to transmit the travel data 121 to the third party server 200 or to prohibit the travel data 121 from being transmitted to the third party server 200 is determined based on the user information.

### Other Embodiments

The above-described embodiments are merely examples, and the present disclosure may be appropriately modified and implemented without departing from the scope thereof. For example, the processes and means described in the present disclosure can be free combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read-only memory (ROM), a random access memory (RAM), an erasable programmable read-only memory (EPROM), an electrically erasable programmable read only memory (EEPROM), a magnetic card, a flash memory, or any type of medium suitable for storing electronic commands such as an optical card.

What is claimed is:

1. An information processing device, comprising a control unit that executes:
receiving first data related to travel from a vehicle;
identifying a first user on the vehicle; and
acquiring user information indicating whether the first user allows to provide a third party with the first data received from the vehicle on which the first user is, wherein
in the user information, when the first user allows to provide the third party with the first data, the control unit transmits the first data to a third party server, and
in the user information, when the first user does not allow to provide the third party with the first data, the control unit prohibits transmitting the first data to the third party server.

2. The information processing device according to claim 1, wherein:
the control unit further executes acquiring owner information indicating whether an owner of the vehicle sets such that the user on the vehicle is able to select whether to allow to provide the third party with the first data; and
in the owner information, when the owner of the vehicle sets such that the user on the vehicle is able to select whether to allow to provide the third party with the first data, the control unit determines, based on the user information, whether to transmit the first data to the third party server or prohibit transmitting the first data to the third party server.

3. The information processing device according to claim 1, further comprising a storage device for storing the user information for each of a plurality of users including the first user.

4. The information processing device according to claim 1, wherein:
the user information is input to an in-vehicle terminal of the vehicle by the first user on the vehicle; and
the control unit receives the user information from the in-vehicle terminal.

5. The information processing device according to claim 1, wherein the vehicle is a vehicle for a car sharing service.
